(19) United States
(12) Patent Application Publication
(10) Pub. No.: US 2022/0100924 A1
(43) Pub. Date: Mar. 31, 2022

(54) METHOD OF MATERIAL CHARACTERIZATION OF ADDITIVE MANUFACTURING (AM) PARTS USING NVH TESTING WITH ACOUSTIC AND/OR MECHANICAL EXCITATION

(71) Applicant: Ford Global Technologies, LLC, Dearborn, MI (US)

(72) Inventor: Yuksel Gur, Ann Arbor, MI (US)

(73) Assignee: Ford Global Technologies, LLC, Dearborn, MI (US)

(21) Appl. No.: 17/039,847

(22) Filed: Sep. 30, 2020

(51) Int. Cl. G06F 30/20; G06F 30/17

(52) U.S. Cl. CPC G06F 30/20; G06F 2119/10; G06F 30/17

(57) ABSTRACT

A method of characterizing a material of an additively manufactured (AM) part includes establishing a computer aided engineering (CAE) model of the AM part, applying an excitation to the AM part, wherein boundary conditions of the AM part are free-free, measuring a vibration response of the AM part at predefined discretization points to generate vibration data, post processing the vibration data to obtain actual noise-vibration-harshness (NVH) modes of the AM part, comparing the actual NVH modes to NVH modes from the CAE model and calculating average differences, and updating the plurality of material properties in the CAE model if the average differences exceed a predetermined threshold. Executing an NVH CAE modal analysis, obtaining updated NVH CAE modes, and comparing new NVH modes to prior NVH modes is repeated with updated material properties if the average differences between updated NVH CAE modes and actual NVH modes are above the predetermined threshold.

### FIELD

The present disclosure relates to additively manufactured parts, and more specifically to materials characterization methods for such additively manufactured parts.

### BACKGROUND

The statements in this section merely provide background information related to the present disclosure and may not constitute prior art.

Additive manufacturing (AM) has undergone significant advancements in recent years, and more particularly in the automotive industry. Automotive parts can now be tailored to meet a variety of load/operating conditions and can be made of both metal and plastic materials.

However, because AM methods and their related materials are relatively new, associated material models for use in computer aided engineering (CAE) are lagging behind. Experience has shown that conventional coupon testing with AM materials, such as by way of example tensile coupons (“dogbone” or “dumbbell” coupons) tested under ASTM D638, often results in inconsistent data, especially for plastic materials. With this inconsistent data, CAE models are not as accurate and reliable as with other more well-known and conventional materials.

These issues related to materials characterization for AM parts, among other modeling and simulation aspects of AM materials/parts, are addressed by the present disclosure.

### SUMMARY

This section provides a general summary of the disclosure and is not a comprehensive disclosure of its full scope or all of its features.

In one form, the present disclosure provides a method of characterizing a material of an additively manufactured part. The method comprises the steps of: (a) establishing a computer aided engineering (CAE) model of the additively manufactured part, the CAE model including a plurality of material properties and running/executing the CAE model with the material properties to obtain natural frequencies (NVH modes) of the additively manufactured part; (b) applying an excitation to the additively manufactured part, wherein boundary conditions of the additively manufactured part are free-free; (c) measuring a vibration response of the additively manufactured part at predefined discretization points to generate vibration data; (d) post processing the vibration data to obtain actual noise-vibration-harshness (NVH) modes of the additively manufactured part; (e) comparing the actual NVH modes to NVH modes from the CAE model and calculating average differences; (f) updating the plurality of material properties if the average differences exceed a predetermined threshold; (g) if the average differences exceed the predetermined threshold, executing an NVH modal analysis in the CAE model with the updated material properties; (h) obtaining updated NVH modes from the CAE model with the updated material properties; and (i) calculating average differences between the updated NVH modes from the CAE model and the actual NVH modes from step (e), wherein steps (f) through (i) are repeated if the average differences are above the predetermined threshold.

In variations of this method, which may be implemented individually or in any combination: the step of applying the excitation comprises at least one of mechanical and acoustic excitation; the step of measuring the vibration response comprises 3D laser vibration measurements at the predefined discretization points on surfaces of the additively manufactured part; the predetermined threshold is greater that 0% and up to 5% of the average differences; the predetermined threshold is about 2%; the free-free boundary conditions are enabled by at least one of an air spring and an elastic support material; the mechanical excitation comprises an impact hammer; the plurality of material properties are linear material properties; the plurality of material properties are selected from the group consisting of modulus of elasticity, Poisson's ratio, and shear modulus of elasticity; the material of the additively manufactured part is selected from the group consisting of a polymer, a metal or metal alloy, a ceramic, and a fiber reinforced material; the additively manufactured part includes pre-manufactured components. The present disclosure further includes an additively manufactured part having material properties characterized according to these methods.

In another form, a method of characterizing a material of an additively manufactured part is provided that includes the steps of: (a) establishing a computer aided engineering (CAE) model of the additively manufactured part, the CAE model including at least one material property and running/executing the CAE model with the at least one material property to obtain natural frequencies (NVH modes) of the additively manufactured part in the CAE model; (b) applying an excitation to the additively manufactured part, wherein boundary conditions of the additively manufactured part are free-free; (c) measuring a vibration response of the additively manufactured part at predefined discretization points to generate vibration data; (d) post processing the vibration data to obtain actual noise-vibration-harshness (NVH) modes; (e) comparing the actual NVH modes to NVH modes from the CAE model and calculating average differences; (f) updating the at least one material property in the CAE model if the average differences exceed a predetermined threshold greater that 0% and up to 5% of the average differences; (g) if the average differences exceed the predetermined threshold, executing an NVH modal analysis in the CAE model with the updated material property; (h) obtaining updated NVH modes from the CAE model with the updated material property; and (i) calculating average differences between the updated NVH modes from the CAE model and the actual NVH modes from step (e), wherein steps (f) through (i) are repeated if the average differences are above the predetermined threshold.

In variations of this method, which may be implemented individually or in any combination: the step of applying the excitation comprises at least one of mechanical and acoustic excitation; the mechanical excitation comprises an impact hammer; the free-free boundary conditions are enabled by at least one of an air spring and an elastic support material; and the at least one material property is a linear material property.

In still another form, an additively manufactured part is provided that has its material properties characterized by: (a) establishing a computer aided engineering (CAE) model of the additively manufactured part, the CAE model including a plurality of material properties and running/executing the CAE model with the material properties to obtain natural frequencies (NVH CAE modes) of the additively manufactured part; (b) applying an excitation to the additively manufactured part, wherein boundary conditions of the additively manufactured part are free-free; (c) measuring a vibration response of the additively manufactured part at predefined discretization points to generate vibration data; (d) post processing the vibration data to obtain actual noise-vibration-harshness (NVH) modes; (e) comparing the actual NVH modes to NVH modes from the CAE model and calculating average differences; (f) updating the plurality of material properties if the average differences exceed a predetermined threshold; (g) if the average differences exceed the predetermined threshold, executing an NVH modal analysis in the CAE model with the updated material properties; (h) obtaining updated NVH modes from the CAE model with the updated material properties; and (i) calculating average differences between the updated NVH modes from the CAE model and the actual NVH modes from step (e), wherein steps (f) through (i) are repeated if the average differences are above the predetermined threshold.

In variations of this form, the additively manufactured part comprises a polymeric material, and in another form, the additively manufactured part comprises a composite material.

Further areas of applicability will become apparent from the description provided herein. It should be understood that the description and specific examples are intended for purposes of illustration only and are not intended to limit the scope of the present disclosure.

### DRAWINGS

In order that the disclosure may be well understood, there will now be described various forms thereof, given by way of example, reference being made to the accompanying drawings, in which:

FIG. 1 is a perspective view of an additively manufactured (AM) part according to the teachings of the present disclosure;

FIG. 2 is a perspective view of the AM part of FIG. 1 in a test set-up, suspended on a soft/elastic material and proximate an excitation device according to the teachings of the present disclosure;

FIG. 3 is a perspective view of the test set-up of FIG. 3 illustrating 3D laser vibration measurement devices configured according to the teachings of the present disclosure;

FIG. 4 is a flowchart illustrating a method of material characterization according to the teachings of the present disclosure;

FIG. 5A is a perspective view of an AM part illustrating a torsional mode in a CAE model according to the teachings of the present disclosure; and

FIG. 5B is a perspective view of discretized points from actual testing, illustrating the torsional mode in testing compared to the CAE model of FIG. 5A.

The drawings described herein are for illustration purposes only and are not intended to limit the scope of the present disclosure in any way.

### DETAILED DESCRIPTION

The following description is merely exemplary in nature and is not intended to limit the present disclosure, application, or uses. It should be understood that throughout the drawings, corresponding reference numerals indicate like or corresponding parts and features.

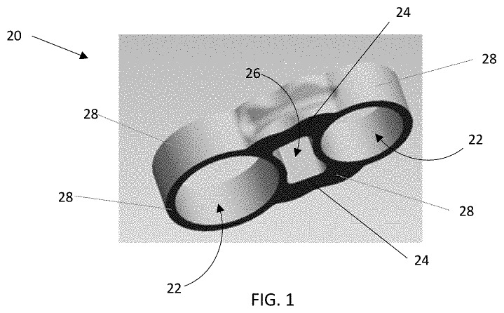

Referring to FIG. 1, an exemplary part manufactured using additive manufacturing (AM) is illustrated and generally referred to herein as an additively manufactured part 20. This particular additively manufactured part 20 includes two opposed openings 22 connected by ribs 24. Further, the ribs 24 are separated by a central opening 26. The additively manufactured part 20 also includes a plurality of surfaces 28 on an exterior portion thereof. The surfaces 28 are generally surfaces generated from a CAD (computer aided design) model and not all surfaces of the additively manufactured part 20 are shown for purposes of clarity.

It should be understood that this additively manufactured part 20 is merely exemplary in order to explain the principles of the present disclosure and that any number of parts having a variety of geometrical configurations may be employed according to the teachings herein. Further, the additively manufactured part 20 may be manufactured with a variety of AM methods and materials. The materials include, by way of example, polymers, metals or metal alloys, ceramic, and fiber (e.g., carbon, glass) reinforced materials (i.e., composite materials). Further, the additively manufactured part 20 in one form includes pre-manufactured components (not shown), which are then joined using AM processes to form the final additively manufactured part 20. Examples of such pre-manufactured components and joining with AM processes are shown in U.S. Pat. No. 10,589,588, which is commonly assigned with the present application and the contents of which are incorporated herein by reference in their entirety.

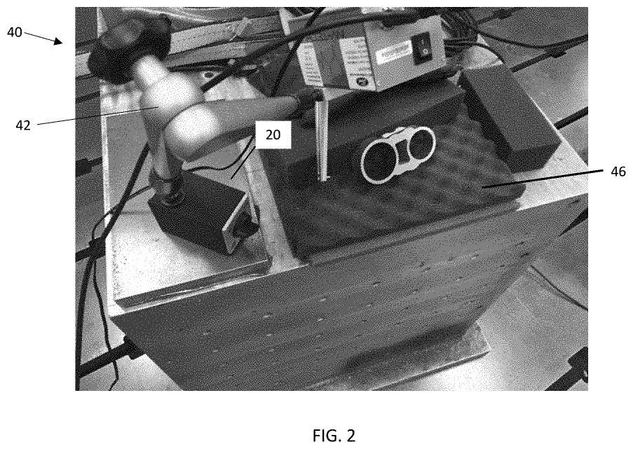

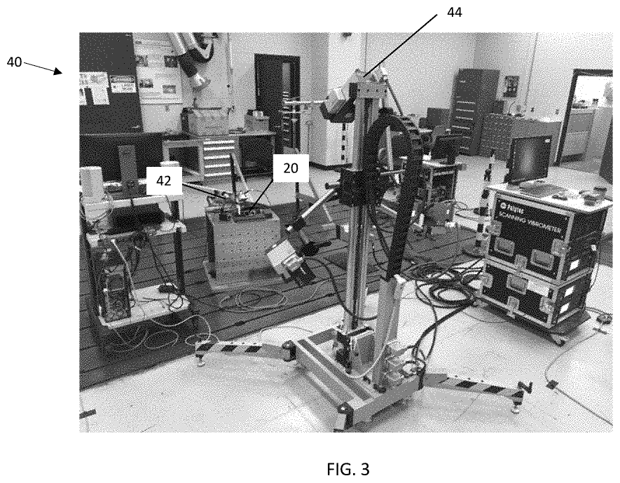

Referring now to FIGS. 2 and 3, a test set-up for characterizing a material of the additively manufactured part 20 is illustrated and generally indicated by reference numeral 40. The test set-up 40 includes an excitation device 42 for applying an excitation to the additively manufactured part 20, which in this form is an automatic impact hammer, or a mechanical excitation. In another form, the excitation device 42 is speaker (not shown), or an acoustic excitation, with white noise or sweep noise excitation. It should be understood that other forms of excitation devices 42 may be employed while remaining within the scope of the present disclosure.

The test set-up 40 further includes a vibration measurement device 44, which in one form is a 3D laser (or scanning laser vibrometer). However, it should be understood that other vibration measurement devices may be employed while remaining within the scope of the present disclosure. As further shown, the additively manufactured part 20 is disposed on an elastic support material 46 (which in this form is a foam material with minimal line/point contact between the foam material and the additively manufactured part 20) in order to simulate free-free boundary conditions during testing. Other means to provide the free-free boundary conditions may include, by way of example, an air spring, or two parallel pretensioned rubber bands/elastic members in a plane perpendicular to a gravitational direction, among others.

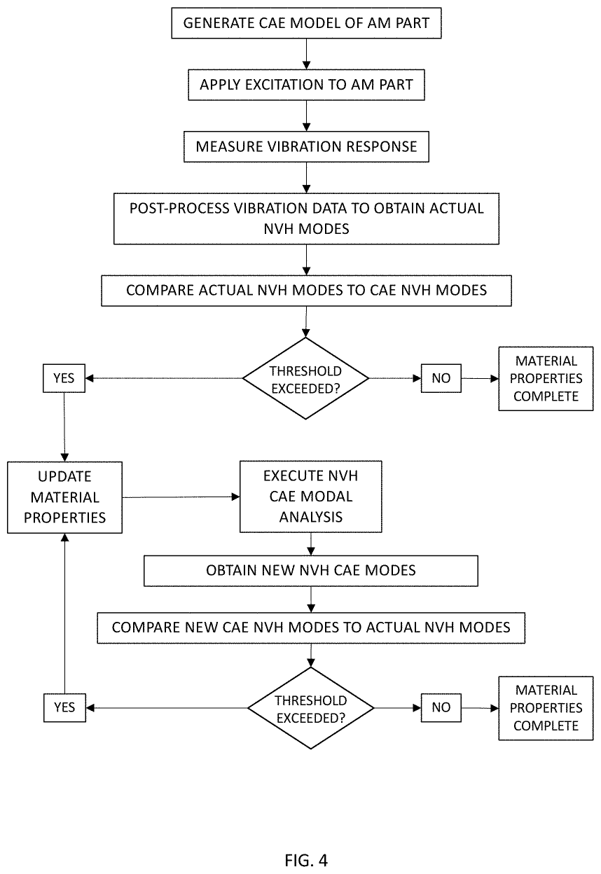

Referring now to FIG. 4, a method of characterizing the material of the additively manufactured part 20 using the test set-up 40 is shown. The method comprises establishing (by generating or accessing) a computer aided engineering (CAE) model of the additively manufactured part 20, the CAE model including a plurality of material properties. The method further includes running the CAE model with the plurality of material properties to obtain the natural frequencies (NVH modes) of the additively manufactured part 20. Using the exemplary test set-up 40 as illustrated and described above, an excitation is applied to the additively manufactured part 20, wherein boundary conditions of the additively manufactured part 20 are free-free. A vibration response of the additively manufactured part 20 is then measured at predefined discretization points to generate vibration data.

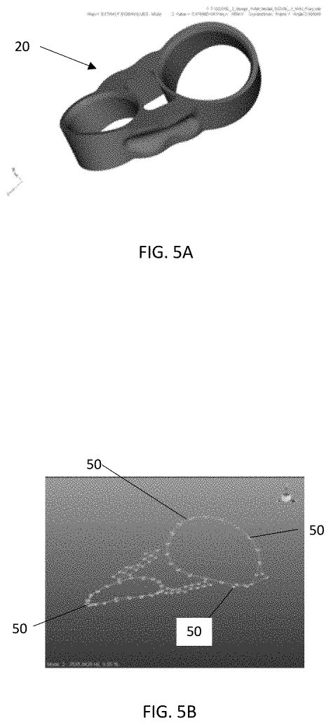

More specifically, and with reference to FIG. 5B, predefined discretization points 50 are generally obtained from a finite element model (FEM) and the associated mesh used for finite element analysis (FEA), which is used in the CAE model. The resolution or spacing of the predefined discretization points 50 is generally small enough to capture displacement of the geometry of the additively manufactured part 20 during testing with a desired accuracy. In one form, discretization point density (distance between adjacent predefined discretization points 50) is less than 3 mm. Further, sampling frequency of the vibration measurement device 44 in this form is 10 KHz, which enables measuring frequency response of the additively manufactured part 20 up to 5 kHz. Generally, the sampling frequency is based upon the highest response frequency of interest for the specific additively manufactured part 20. As shown in this exemplary test set-up, three (3) lasers are directed at each predefined discretization point 50. The vibration response is measured for each predefined discretization point 50 for each excitation with the three (3) lasers. This excitation-measurement step is then repeated for each predefined discretization point 50. The predefined discretization points 50 shown in FIG. 5B are from actual testing, illustrating the torsional mode in testing compared to the CAE model of FIG. 5A.

After the vibration response of the additively manufactured part 20 is measured with the vibration measurement device 44, vibration data is post processed to obtain actual noise-vibration-harshness (NVH) modes (or natural frequencies) of the additively manufactured part 20. In one form, the vibration data is post processed for all predefined discretization points 50 according to methods known in the art.

Next, these actual noise-vibration-harshness (NVH) modes are compared to NVH modes from the CAE model, and average differences between actual NVH modes and CAE modes are calculated. These average differences are compared to a predetermined threshold, and if the average differences exceed a predetermined threshold, material properties (and in one form, at least one material property) of the additively manufactured part 20 are updated in the CAE model. After the material property update, the NVH modal analysis in the CAE model is executed with the updated material properties. Updated NVH modes from the CAE model are then obtained using the updated material properties, and average differences are once again calculated with the updated NVH modes from the CAE model. This process of executing the CAE model with updated material properties, updating NVH modes in the CAE model, and calculating average differences between the updated NVH modes from the CAE model and the actual NVH modes is repeated until the average differences are below the predetermined threshold. Once the average differences are below the predetermined threshold, the material properties of the additively manufactured part 20 are finally determined.

In one form, the predetermined threshold is less than 2% of the average differences, however a range from greater that 0% and up to 5% of the average differences may also provide acceptable material properties. The material properties are linear and include modulus of elasticity (E), Poisson's ratio (V), and shear modulus of elasticity (G) in one form of the present disclosure. For an isotropic CAE model of the additively manufactured part 20, only one of each of these properties E, V, and G exists. However, for orthotropic material models, there are three (3) material properties for each 3 dimensional space (x, y, and z), and thus a total of nine (9) material properties exist, namely, Ex, Ey, Ez, Gxy, Gyz, Gxz, Vxy, Vyz, and Vxz.

Generally, in order to update material properties, if the updated NVH modes from the CAE model are lower than the actual/test NVH modes, material properties related to stiffness as set forth above are increased for the next iteration. Similarly, if the updated NVH modes from the CAE model are higher than the actual/test NVH modes, material properties related to stiffness are decreased for the next iteration. One or more of the material properties as set forth above may be increased or decreased in order to converge on NVH mode differences lower than the predetermined threshold.

Referring now to FIGS. 5A and 5B, the additively manufactured part 20 was tested using the test set-up 40 as illustrated and described herein. In these figures, the additively manufactured part 20 is shown under a test mode of torsion. Different modes were tested, including: (1) 1^{st} bending; (2) torsion; (3) 1^{st} in-plane bending; (4) 2^{nd} bending; and (5) 2^{nd} in-plane bending. NVH modes of the CAE model, the actual test NVH modes, and differences are illustrated in Table 1:

TABLE 1
CAE and Actual Test Data Comparison

| Mode No. and Shape | CAE (Hz) | Actual Test (Hz) | Difference |
|---|---|---|---|
| 1 - 1^{st} bending | 3173 | 3104 | 2.1% |
| 2 - Torsion | 3584 | 3536 | 1.3% |
| 3 - 1^{st} in-plane bending | 4624 | 4512 | 2.4% |
| 4 - 2^{nd} bending | 5021 | 4954 | 1.3% |
| 5 - 2^{nd} in-plane bending | 5599 | 5480 | 2.1% |

The method as described above and shown in FIG. 4 was carried out until the average differences between the updated NVH modes from the CAE model and the actual NVH modes was less that 2%, which in this case was averaged across all modes to result in an average difference of 1.8%. However, as set forth above, it should be understood that different predetermined thresholds may be set according to specific application requirements while remaining within the scope of the present disclosure. Further, a plurality of AM parts can be tested in order to arrive at a statistically significant number of data points to establish material properties. Further, with this method, different allowables thresholds may be achievable, which would result in lighter weight parts. For example, rather than using B-basis allowables (or T90 where at least 90% of the population of material values is expected to equal or exceed this tolerance bound with 95% confidence), A-basis allowables (or T99 where at least 99% of the population of material values is expected to equal or exceed this tolerance bound with 95% confidence) may be used. In other words, more robust safety factors can be achieved with the teachings of the present disclosure, thus enabling lighter weight designs for AM parts in a variety of applications, including motor vehicles.

Unless otherwise expressly indicated herein, all numerical values indicating mechanical/thermal properties, compositional percentages, dimensions and/or tolerances, or other characteristics are to be understood as modified by the word “about” or “approximately” in describing the scope of the present disclosure. This modification is desired for various reasons including industrial practice, material, manufacturing, and assembly tolerances, and testing capability.

As used herein, the phrase at least one of A, B, and C should be construed to mean a logical (A OR B OR C), using a non-exclusive logical OR, and should not be construed to mean “at least one of A, at least one of B, and at least one of C.”

The description of the disclosure is merely exemplary in nature and, thus, variations that do not depart from the substance of the disclosure are intended to be within the scope of the disclosure. Such variations are not to be regarded as a departure from the spirit and scope of the disclosure.

What is claimed is:

1. A method of characterizing a material of an additively manufactured part, the method comprising the steps of:
(a) establishing a computer aided engineering (CAE) model of the additively manufactured part, the CAE model including a plurality of material properties and running the CAE model with the plurality of material properties to obtain NVH modes of the additively manufactured part;
(b) applying an excitation to the additively manufactured part, wherein boundary conditions of the additively manufactured part are free-free;
(c) measuring a vibration response of the additively manufactured part at predefined discretization points to generate vibration data;
(d) post processing the vibration data to obtain actual noise-vibration-harshness (NVH) modes of the additively manufactured part;
(e) comparing the actual NVH modes to NVH modes from the CAE model and calculating average differences;
(f) updating the plurality of material properties in the CAE model if the average differences exceed a predetermined threshold;
(g) if the average differences exceed the predetermined threshold, executing an NVH modal analysis in the CAE model with the updated material properties;
(h) obtaining updated NVH modes from the CAE model with the updated material properties; and
(i) calculating average differences between the updated NVH modes from the CAE model and the actual NVH modes from step (e),
wherein steps (f) through (i) are repeated if the average differences are above the predetermined threshold.

2. The method according to claim 1, wherein the step of applying the excitation comprises at least one of mechanical and acoustic excitation.

3. The method according to claim 1, wherein the step of measuring the vibration response comprises 3D laser vibration measurements at the predefined discretization points on surfaces of the additively manufactured part.

4. The method according to claim 1, wherein the predetermined threshold is greater that 0% and up to 5% of the average differences.

5. The method according to claim 1, wherein the predetermined threshold is less than about 5%.

6. The method according to claim 1, wherein the free-free boundary conditions are enabled by at least one of an air spring and an elastic support material.

7. The method according to claim 2, wherein the mechanical excitation comprises an impact hammer.

8. The method according to claim 1, wherein the plurality of material properties are linear material properties.

9. The method according to claim 1, wherein the plurality of material properties are selected from the group consisting of modulus of elasticity, Poisson's ratio, and shear modulus of elasticity.

10. The method according to claim 1, wherein the material of the additively manufactured part is selected from the group consisting of a polymer, a metal or metal alloy, a ceramic, and a fiber reinforced material.

11. The method according to claim 1, wherein the additively manufactured part includes pre-manufactured components that enable the additively manufactured part.

12. An additively manufactured part having material properties characterized according to the method of claim 1.

13. A method of characterizing a material of an additively manufactured part, the method comprising the steps of:
(a) establishing a computer aided engineering (CAE) model of the additively manufactured part, the CAE model including at least one material property and running the CAE model with the at least one material property to obtain NVH modes of the additively manufactured part;
(b) applying an excitation to the additively manufactured part, wherein boundary conditions of the additively manufactured part are free-free;
(c) measuring a vibration response of the additively manufactured part at predefined discretization points to generate vibration data;
(d) post processing the vibration data to obtain actual noise-vibration-harshness (NVH) modes; and
(e) comparing the actual NVH modes to NVH modes from the CAE model and calculating average differences;
(f) updating the at least one material property in the CAE model if the average differences exceed a predetermined threshold greater that 0% and up to 5% of the average differences;
(g) if the average differences exceed the predetermined threshold, executing an NVH modal analysis in the CAE model with the updated material property;
(h) obtaining updated NVH modes from the CAE model with the updated material property; and
(i) calculating average differences between the updated NVH modes from the CAE model and the actual NVH modes from step (e),
wherein steps (f) through (i) are repeated if the average differences are above the predetermined threshold.

14. The method according to claim 13, wherein the step of applying the excitation comprises at least one of mechanical and acoustic excitation.

15. The method according to claim 13, wherein the mechanical excitation comprises an impact hammer.

16. The method according to claim 13, wherein the free-free boundary conditions are enabled by at least one of an air spring and an elastic support material.

17. The method according to claim 13, wherein the at least one material property is a linear material property.

18. An additively manufactured part having material properties characterized by:
(a) establishing a computer aided engineering (CAE) model of the additively manufactured part, the CAE model including a plurality of material properties and running/executing the CAE model with the plurality of material properties to obtain NVH modes of the additively manufactured part;
(b) applying an excitation to the additively manufactured part, wherein boundary conditions of the additively manufactured part are free-free;
(c) measuring a vibration response of the additively manufactured part at predefined discretization points to generate vibration data;
(d) post processing the vibration data to obtain actual noise-vibration-harshness (NVH) modes; and
(e) comparing the actual NVH modes to NVH modes from the CAE model and calculating average differences;
(f) updating the plurality of material properties in the CAE model if the average differences exceed a predetermined threshold;
(g) if the average differences exceed the predetermined threshold, executing an NVH modal analysis in the CAE model with the updated material properties;
(h) obtaining updated NVH modes from the CAE model with the updated material properties; and
(i) calculating average differences between the updated NVH modes from the CAE model and the actual NVH modes from step (e),
wherein steps (f) through (i) are repeated if the average differences are above the predetermined threshold.

19. The additively manufactured part according to claim 18, wherein the predetermined threshold is greater that 0% and up to 5% of the average differences.

20. The additively manufactured part according to claim 18, wherein the additively manufactured part comprises a composite material.
